(19) United States
(12) Patent Application Publication
(10) Pub. No.: US 2015/0285327 A1
(43) Pub. Date: Oct. 8, 2015

(54) Multiphase Materials For Stress Wave Steering And Methods Of Providing Same

(71) Applicants: Julian Jose Rimoli, Smyrna, GA (US); Filippo Casadei, Atlanta, GA (US); Massimo Ruzzene, Smyrna, GA (US)

(72) Inventors: Julian Jose Rimoli, Smyrna, GA (US); Filippo Casadei, Atlanta, GA (US); Massimo Ruzzene, Smyrna, GA (US)

(73) Assignee: GEORGIA TECH RESEARCH CORPORATION, Atlanta, GA (US)

(21) Appl. No.: 14/035,919

(22) Filed: Sep. 24, 2013

Related U.S. Application Data
(60) Provisional application No. 61/704,920, filed on Sep. 24, 2012.

(51) Int. Cl. F16F 15/04; G10K 11/165

(52) U.S. Cl. CPC F16F 15/04; G10K 11/165

(57) ABSTRACT

An exemplary embodiment of the present invention provides a method of achieving a desired attenuation pattern in a material when a force is applied incident at least a portion of the material. The method comprises providing a multiphase material in a decompressed state, the multiphase material comprising a matrix material, a first periodic lattice of first inclusions positioned with the matrix material, and a second periodic lattice of second inclusions positioned within the matrix. The first periodic lattice of first inclusions can have a first set of lattice characteristics, and the second periodic lattice of second inclusions can have a second set of lattice characteristics different than the first set of lattice characteristics. The method can further comprise selecting the first and second sets of lattice characteristics based on a desired stress wave attenuation pattern when a force is applied incident to at least a portion of the multiphase material.

### CROSS-REFERENCE TO RELATED APPLICATIONS

This application claims the benefit of U.S. Provisional Application Ser. No. 61/704,920, filed on 24 Sep. 2012, which is incorporated herein by reference in its entirety as if fully set forth below.

### TECHNICAL FIELD OF THE INVENTION

The various embodiments of the present disclosure relate generally to materials with periodic lattices. More particularly, the various embodiments of the present invention are directed to multiphase materials for attenuating stress waves in predetermined patterns.

### BACKGROUND OF THE INVENTION

Recent advances in the area of blast and ballistic impacts have enabled the detailed characterizations of such events in terms of pressures at the impact point and tracking of longitudinal and shear waves propagating through the medium under consideration. Conventional research on materials for blast and ballistic impact mitigation has focused on evaluating materials and structural solutions based on global deformation characteristics and on the energy stored and dissipated. Such studies have overwhelmingly shown that multi-material, layered, heterogeneous, hierarchical or hybrid configurations greatly outperform monolithic solutions in terms of energy absorption and weight. For this reason, structural hierarchy has been pursued over multiple length scales to include atomistic, grain level, along with meso and macro structural heterogeneities. These conventional methods attempt to employ and properly combine various classes of materials among metals, ceramics, polymers and composites to achieve functionality that is greater than the sum of the individual constituents or of the weakest link among them.

The great majority of the conventional hybrid and heterogeneous designs feature periodic or at least ordered arrangement of the constituents. Proper exploitation of the geometry, length scale, materials, and topology of such arrangements offers unprecedented opportunities to further expand and enhance the performance of armor materials. Specifically, stress wave management can be pursued as an objective for the design of a novel class of structured material, here generally denoted as Multiphase Materials (“MMs”). Wave management, as used herein, refers to the ability of a MM to guide, alter, redirect, or steer mechanical waves.

Extensive research has been devoted to wave guiding in electromagnetic and acoustic (mechanical) media, and to the development of photonics and phononic materials. Much of the work is based on the bandgap properties of such materials, which are the result of periodic modulations of electromagnetic properties (permittivity and permeability) and acoustic properties (mass and stiffness). Bandgaps represent ranges of frequencies where waves do not propagate in the medium. As such, bandgap design has been applied for a variety of applications which include vibration isolation, noise attenuation, as well as wave guiding, localization, and altering. With respect to high intensity stress waves, the effect of shock waves and bandgaps has been studied theoretically, and it has been concluded that material heterogeneity results in dispersion through which it is possible to counter the destructive effects of the shocks.

Conventional have explored the effects of periodic structures (and possible bandgaps) in armor materials. Those studies, however, do not contain a detailed discussion of the effect of nonlinearities on bandgaps as needed under shock conditions. Along with large strains and associated nonlinearities, the effectiveness of bandgap materials limited to specific frequency ranges limits the applicability of these concepts for the attenuation of waves resulting from broadband events such as blasts and high velocity impacts.

Nonlinear response of periodic materials is receiving increasing attention, and much of the literature in this field is devoted to the analysis of solutions for shock attenuation. For example, periodic chains of granular particles are being investigated due to their highly nonlinear behavior, which has led to the observation of new wave propagation phenomena such as the support of the solitary waves characterized by constant spatial wavelength and amplitude-dependent speed of propagation. Heterogeneous granular systems have also been proposed for energy trapping and shock disintegration, and recently have been investigated for stress wave mitigation.

While much of the literature on periodically layered or generally heterogeneous systems mostly focuses on the transmission of waves, and on their guiding through bandgaps, conventional techniques have failed to focus on the redirection of waves due to material anisotropy.

Therefore, there is a desire for improved materials capable of achieving a desired stress wave attenuation pattern in response to application of an outside force. Various embodiments of the present invention address these desires.

### BRIEF SUMMARY OF THE INVENTION

The present invention relates to multiphase materials for attenuating stress waves in a predetermined pattern and methods of providing such materials. An exemplary embodiment of the present invention provides a multiphase material for attenuating stress waves in a predetermined pattern when a force is applied incident to at least a portion of the material. The multiphase material can comprising a matrix material, a first periodic lattice of first inclusions, and a second periodic lattice of second inclusions. The first periodic lattice of first inclusions can be positioned within the matrix material and can have a first set of predetermined lattice characteristics. The second periodic lattice of second inclusions can be positioned within the matrix material and can have a second set of predetermined lattice characteristics. The second set of predetermined lattice characteristics can be different than the first set of predetermined lattice characteristics. The first and second sets of predetermined lattice characteristics can be selected based on a desired stress wave attenuation pattern when a force is applied incident to at least a portion of the multiphase material.

In some embodiments of the present invention, the first and second sets of predetermined lattice characteristics can each comprise a distinct periodic pattern, inclusion material, and inclusion size.

In some embodiments of the present invention, the first inclusions can be softer than the second inclusions.

In some embodiments of the present invention, the first set of predetermined lattice characteristics can comprise a first periodic pattern and the second set of predetermined lattice characteristics can comprise a second periodic pattern. In some embodiments, the first and second periodic patterns are the same. In some embodiments, the first and second periodic patterns are different.

In some embodiments of the present invention, at least one of the first periodic pattern and the second periodic pattern can change when a force is applied incident to at least a portion of the multiphase material.

In some embodiments of the present invention, at least one of the first periodic pattern and the second periodic pattern and at least one of a shape of the first inclusions and a shape of the second inclusions changes, when a force is applied incident to at least a portion of the multiphase material.

Another exemplary embodiments of the present invention provides a method of achieving a desired attenuation pattern in a material when a force is applied incident at least a portion of the material. The method can comprise providing a multiphase material in a decompressed state. The multiphase material can comprise a matrix material, a first periodic lattice of first inclusion, and a second periodic lattice of second inclusions. The first periodic lattice of first inclusions can be positioned within the matrix material and can have a first set of lattice characteristics. The second periodic lattice of second inclusions can be positioned within the matrix material and can have a second set of lattice characteristics. The second set of lattice characteristics can be different than the first set of lattice characteristics. The method can also comprise selecting the first and second sets of lattice characteristics based on a desired stress wave attenuation pattern when a force is applied incident to at least a portion of the multiphase material.

In some embodiments of the present invention, selecting the first and second sets of lattice characteristics comprises selecting a distinct periodic pattern, inclusion material, and inclusion size for each of the first and second sets of lattice characteristics.

In some embodiments of the present invention, the first inclusions are softer than the second inclusions.

In some embodiments of the present invention, the first set of lattice characteristics comprises a first periodic pattern and the second set of lattice characteristics comprises a second periodic pattern, when the multiphase material is in the decompressed state.

In some embodiments of the present invention, the method further comprises receiving a force incident to at least a portion of the multiphase material. The force can cause the multiphase material to transition from a decompressed state to a compressed state. The first set of lattice characteristics can comprise a third periodic pattern different from the first periodic pattern, and the second set of lattice characteristics can comprise a fourth periodic pattern different than the second periodic pattern, when the multiphase material is in the compressed state.

In some embodiments of the present invention, the force can impart stress on the multiphase material resulting in stress waves propagating through the multiphase material. The stress waves can follow the desired stress wave attenuation pattern.

In some embodiments of the present invention, the stress waves have wavelengths larger than a lattice constant of the first or second periodic lattices.

In some embodiments of the present invention, the first set of lattice characteristics comprises a first periodic pattern and a first inclusion shape and the second set of lattice characteristics comprises a second periodic pattern and a second inclusion shape, when the multiphase material is in the decompressed state.

In some embodiments of the present invention, the method further comprises receiving a force incident to at least a portion of the multiphase material. The force can cause the multiphase material to transition from a decompressed state to an intermediate state and then to a compressed state. The first set of lattice characteristics can comprise a third inclusion shape different from the first inclusion shape, and the second set of lattice characteristics comprises a fourth inclusion shape different than the second inclusion shape, when the multiphase material is in the intermediate state. The first set of lattice characteristics can comprise a third periodic pattern different from the first periodic pattern, and the second set of lattice characteristics can comprise a fourth periodic pattern different than the second periodic pattern, when the multiphase material is in the compressed state.

Another exemplary embodiment of the present invention provides a method of directing stress waves through a material. The method can comprise providing a material in a decompressed state and receiving a force incident to at least a portion of the material, such that the force causes the material to transition from the decompressed state to a compressed state and imparts stress waves that attenuate through the material. The material can comprise a matrix, a first periodic lattice of first inclusions, and a second periodic lattice of second inclusions. The first and second periodic lattices of first and second inclusions, respectively, can be positioned within the matrix. The first periodic lattice of first inclusions can have a first periodic pattern, the first inclusions can have a first inclusion shape, the second periodic lattice can have a second periodic pattern, and the second inclusions can have a second inclusion shape, when the material is in the decompressed state. The first periodic lattice can have a third periodic pattern different from the first periodic pattern, the first inclusions can have a third inclusion shape different from the first inclusion shape, and the second periodic lattice can have a fourth periodic pattern different from the second periodic pattern, when the material is in the compressed state. The first periodic pattern, the first inclusion shape, the second periodic pattern, and the second periodic inclusion shape can be selected to achieve a desired attenuation pattern for the stress waves.

In some embodiments of the present invention, the stress waves have wavelengths larger than a lattice constant of the first or second periodic lattices.

In some embodiments of the present invention, receiving the force can cause the material to transition from the decompressed state to an intermediate state, and then to the compressed state. The first periodic lattice can have the first periodic pattern, the first inclusions can have the third inclusion shape, and the second periodic lattice can have the second periodic pattern, when the material is in the intermediate state.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The following Detailed Description of the Invention is better understood when read in conjunction with the appended drawings. For the purposes of illustration, there is shown in the drawings exemplary embodiments, but the subject matter is not limited to the specific elements and instrumentalities disclosed.

FIGS. 1A-E provide an illustration of a multiphase material, in accordance with an exemplary embodiment of the present invention.

FIGS. 2A-B provide an illustration of a stress wave attenuation pattern in a multiphase material, in accordance with an exemplary embodiment of the present invention.

### DETAILED DESCRIPTION OF THE INVENTION

To facilitate an understanding of the principles and features of the present invention, various illustrative embodiments are explained below. To simplify and clarify explanation, the invention is described below as applied to applications where materials may be subjected to outside forces. For example, various embodiments of the present find applications in the field of ballistic impacts, sporting equipment, safety equipment, and the like. Additionally, those skilled in the art would understand the various embodiments of the present invention also find application in many other areas where it may be desired to attenuate and steer stress waves traversing through a material cause by a force applied to that material.

The components, steps, and materials described hereinafter as making up various elements of the invention are intended to be illustrative and not restrictive. Many suitable components, steps, and materials that would perform the same or similar functions as the components, steps, and materials described herein are intended to be embraced within the scope of the invention. Such other components, steps, and materials not described herein can include, but are not limited to, similar components or steps that are developed after development of the invention.

The present invention focuses on the effect of material heterogeneities and topology on directional wave propagation. MM topology is considered as a factor that influences the equivalent mechanical properties of the medium, under the assumption that characteristics wavelengths are larger than the unit cell size. This ensures that the performance is observed over broad ranges of frequency, and it does not rely on internal dynamics of the unit cell as in the case of bandgap analysis. As topology is a major parameter that influences wave directionality in MMs, adaptive configurations are provided. Adaptivity is achieved through the re-arrangement of the constituents which may be triggered by an external stimulus, or more interestingly, by the stress wave itself. This switching behavior is useful for stress wave attenuation for two main reasons: (i) the mechanical properties at low and high loading levels can differ significantly as lattice symmetries are affected by the phase transformation, and (ii) the full loading cycle exhibits hysteresis, which corresponds to the energy dissipated during the forward and reverse transformations. Topology switches can alter the wave path and be beneficial to stress mitigation, while energy dissipation can mitigate the destructive effects of the propagating stresses. The present invention also focuses on dynamically, stress-induced topological switches in matrix-inclusion systems at the mesoscale. Atomistic configurations are considered as an inspiration to obtain MMs with adaptive topologies and related wave propagation characteristics. Thus, the present invention allows for adaptive wave directionality and energy dissipation.

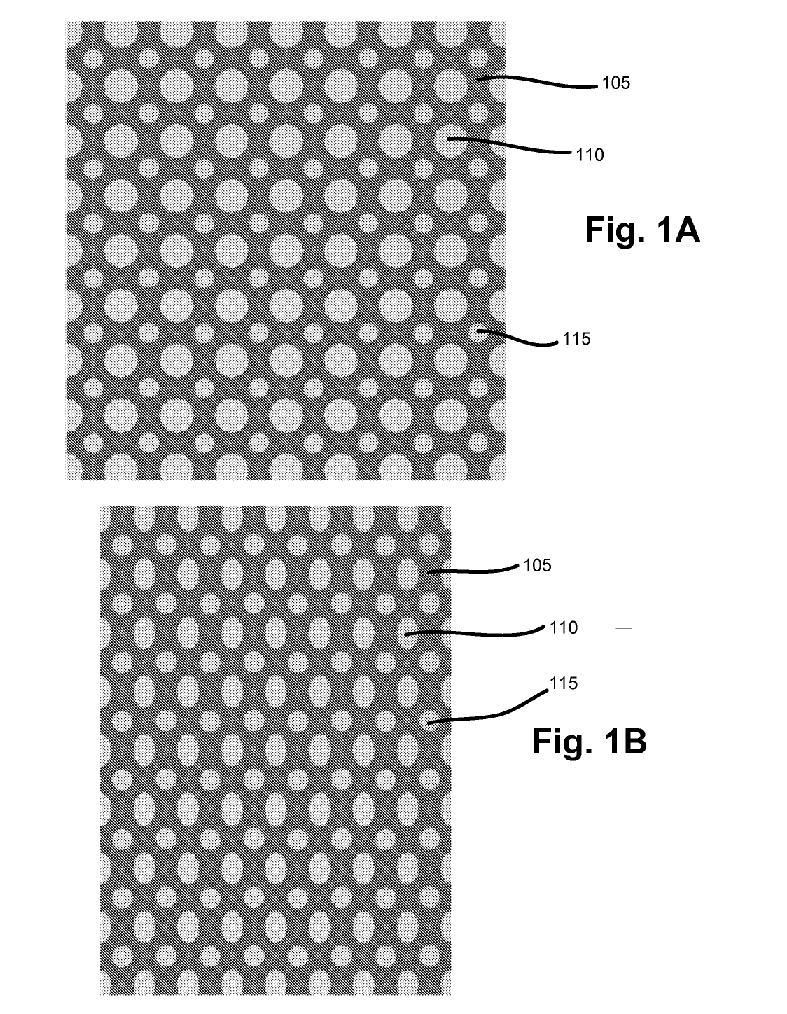

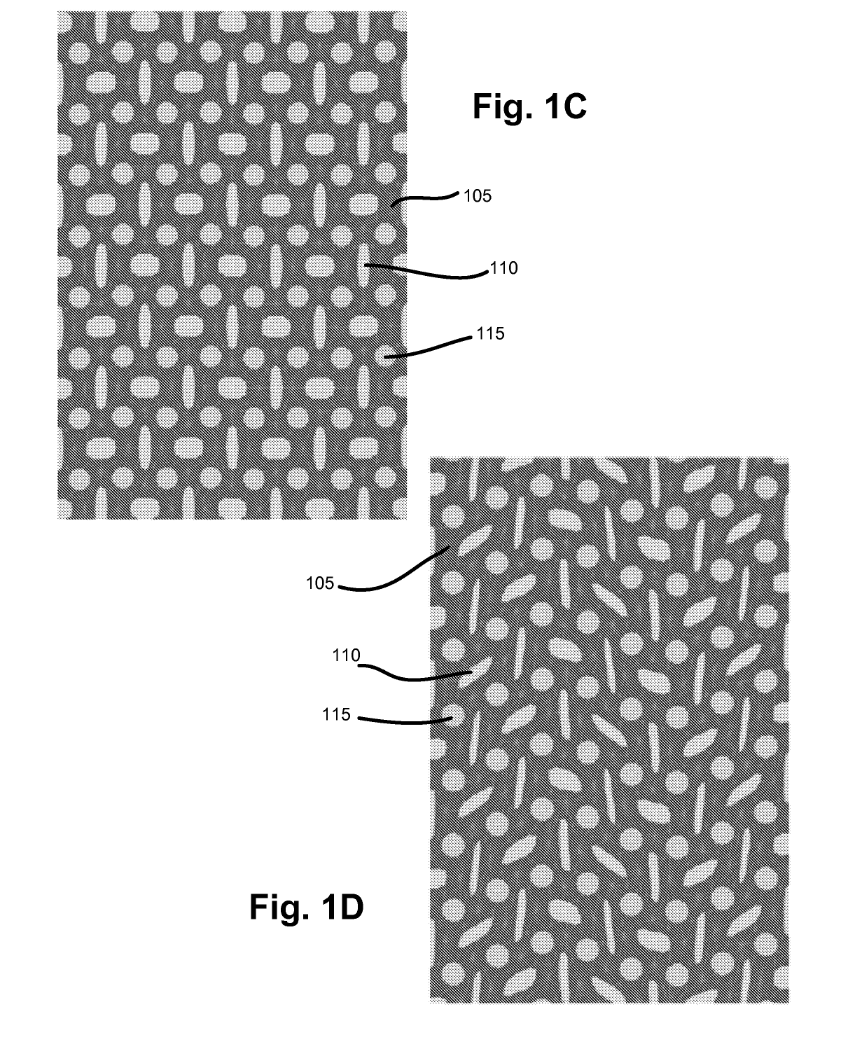

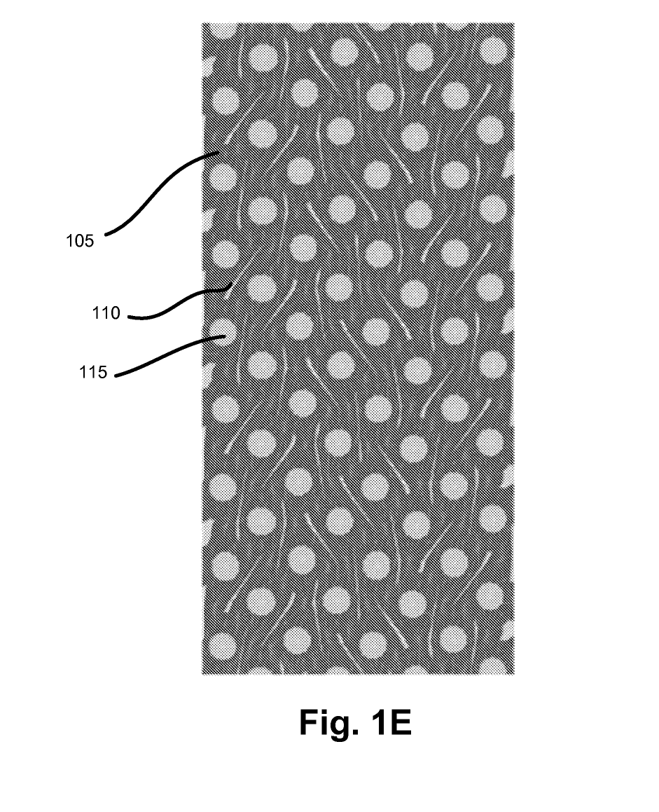

The present invention provides multiphase materials for attenuating stress waves in a predetermined pattern when a force is applied incident to at least a portion of the material. A shown in FIG. 1A, an exemplary embodiment of the present invention provides a multiphase material comprising a matrix material 105, a first periodic lattice of first inclusions 110, and a second periodic lattice of second inclusions 115. The matrix material 105 can be many matrix materials known in the art, including, but not limited to, structural metals (e.g., aluminum, steel, titanium, etc.), rubbers, polymers, epoxies, and the like. The first and second inclusions 110 115 can comprise many different materials known in the art, including but not limited to, structural metals (e.g., aluminum, steel, titanium, etc.), rubbers, polymers, epoxies, and the like. The first periodic lattice of first inclusions 110 can be positioned with the matrix material 105. The second periodic lattice of second inclusions can also be positioned within the matrix material 105. The first and second periodic lattices can have a first and second set of predetermined lattice characteristics, respectively. The lattice characteristics can include, but are not limited to, inclusion shape, inclusion size, inclusion hardness, inclusion material, lattice periodic pattern, unit cell size, and the like. It is through the selection of these first and second sets of lattice characteristics that a desired stress wave attenuation pattern can be achieved when a force is applied incident to at least a portion of the multiphase material.

In some embodiments of the present invention, the first inclusions 110 can be softer than the second inclusions. Thus, the first inclusions 110 can allow for the compression of the material when the material is exposed to an outside force.

The compression simulation for the exemplary material shown in FIGS. 1A-E will now be described, in which a BCC lattice periodic patter is shown composed of 8×16 unit cells. The response of the material under compression can be simulated using a finite-element computational framework based on a Lagrangian finite deformation formulation of the equations of motion. The spatial discretization of the specimen geometry utilizes 3-node triangular elements. The mesh adopted for the analysis of the specimen comprises 8192 elements. Time integration is performed with the explicit, second order accurate, central-difference scheme, which falls within the Newmark family of time stepping algorithms. The response of the matrix and inclusion materials can be assumed to be Neo-Hookean with a strain energy density given by Equation 1 where F is the deformation gradient and μ and λ are the elastic Lame's constants.

$$W ( F ) = \frac{1}{2} {λ ( log ( det F ) )}^{2} - μlog ( det F ) + \frac{1}{2} {μ ( tr ( {F}^{T} F ) - 3.0 )}^{2} \qquad Equation 1$$

FIGS. 1A-E illustrate results obtained through fully nonlinear finite element simulations for the compression of the BCC system. FIG. 1A illustrates the initial unloaded configuration of the system. FIGS. 1B-1E show how the system evolves as the compressive load increases. Initially, most of the deformation of the material is attained through the uniform deformation of the softer inclusions, which can change shape and become elliptic with their major axis aligned with the vertical direction, as shown in FIG. 1B. At certain trigger level, a first instability develops resulting in a pattern of vertically and horizontally aligned elliptic inclusions, as shown by FIG. 1C. A further increase in the load alters the lattice periodic pattern of the inclusions, resulting in a zig-zag pattern in the harder inclusions, as shown in FIG. 1D. Finally, for very high loads, the material attains a closed pack configuration of its hard inclusions resulting in a simple cubic configuration with its [1 0 0] axis rotated 45° with respect to the horizontal axis direction, as shown in FIG. 1E. That is, the application of a high compressive load, e.g., an external force on this particular MM induces a domain switch of its lattice from BCC to a simple cubic structure.

The transition from the initial to the final configuration can be dictated by the development of two different kinds of instabilities. A first instability takes place at the soft inclusion level with a pattern of vertical and horizontal ellipses. This instability along, however, does not lead to the desired final configuration, which obtains the desired stress wave attenuation pattern. A second type of instability, shown in FIG. 1D, develops at higher loading levels. This second instability can be interpreted a column buckling of the hard inclusions.

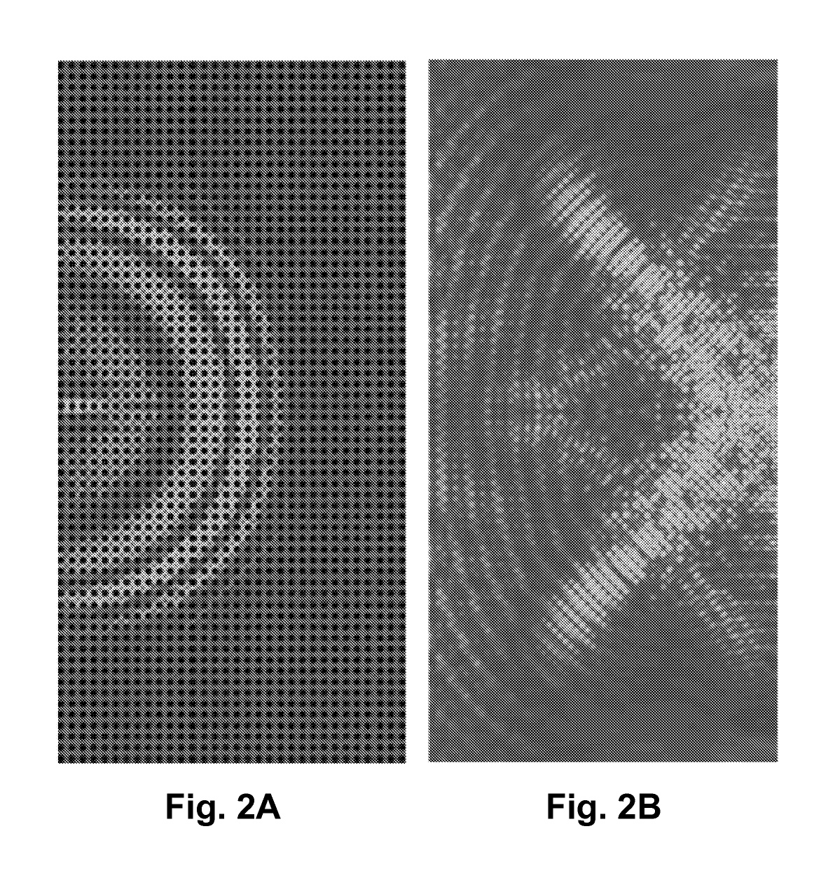

The stress wave attenuation pattern of both the BCC and simple cubic configurations are shown in FIGS. 2A-B. Before the compressive load is applied, the BCC system behaves as an isotropic media for wave propagation in the considered low frequency range, as shown in FIG. 2A. On the other hand, the system obtained after the domain switch exhibits a radically different behavior, with a clear preferred directionality at 45° after the stress induced domain switch, as shown in FIG. 2B.

As discussed above, FIGS. 1A-1B illustrate the effect of an outside force on an exemplary embodiment of the present invention. As shown in FIG. 1A, the first and second sets of periodic inclusions can have first and second sets of predetermined lattice characteristics, respectively. A shown in FIG. 1A, the first set of predetermined lattice characteristics can comprise a first periodic pattern the second set of predetermined lattice characteristics comprises a second periodic pattern. For example, the predetermined lattice characteristics can form a BCC periodic pattern. The present invention is not limited to any specific patterns though. Instead, as those skilled in the art would appreciate, the lattices can take many different periodic patterns which can be predetermined based on a desired stress wave attenuation pattern.

As shown in FIGS. 1D-E, in some embodiments of the present invention, at least one of the first periodic pattern and the second periodic pattern changes when a force is applied incident to at least a portion of the multiphase material. As used herein, a change in periodic pattern means that the arrangement and/or orientation of the unit cells making up the periodic lattices changes. Only a change in the inclusion shape/size does not mean a change in periodic patter as the term is used herein.

As also shown in FIG. 1D-E, at least one of the first periodic pattern and the second periodic pattern and at least one of a shape of the first inclusions 110 and a shape of the second inclusions changes, when a force is applied incident to at least a portion of the multiphase material.

In addition to multiphase materials, exemplary embodiments of the present invention also provide methods of achieving a desired attenuation pattern in a material when a force is applied incident at least a portion of the material. In an exemplary embodiment of the present invention, the method comprises providing a multiphase material in a decompressed state and selecting the first and second sets of lattice characteristics based on a desired stress wave attenuation pattern when a force is applied incident to at least a portion of the multiphase material.

In some embodiments of the present invention, the step of selecting the first and second sets of lattice characteristics can comprise selecting a distinct periodic pattern, inclusion material, and inclusion size for each of the first and second sets of lattice characteristics. In some embodiments, the first inclusions 110 are softer than the second inclusions, thus allowing compression of the material.

In some embodiments of the present invention, the first set of lattice characteristics comprises a first periodic pattern and the second set of lattice characteristics comprises a second periodic pattern, when the multiphase material is in the decompressed state.

The method can further comprise receiving a force incident to at least a portion of the multiphase material, the force causing the multiphase material to transition from a decompressed state to a compressed state. The first set of lattice characteristics can comprise a third periodic pattern different from the first periodic pattern and the second set of lattice characteristics comprises a fourth periodic pattern different than the second periodic pattern, when the multiphase material is in the compressed state. The force can impart stress on the multiphase material resulting in stress waves propagating through the multiphase material. Due to the lattice characteristics in the compressed state, the stress waves can follow the desired stress wave attenuation pattern.

In some embodiments of the invention, the first set of lattice characteristics comprises a first periodic pattern and a first inclusion shape and the second set of lattice characteristics comprises a second periodic pattern and a second inclusion shape, when the multiphase material is in the decompressed state. The method can further comprise receiving a force incident to at least a portion of the multiphase material, wherein the force causes the multiphase material to transition from a decompressed state to an intermediate state and then to a compressed state, as shown in FIGS. 1A-1E. The first set of lattice characteristics comprises a third inclusion shape different from the first inclusion shape and/or the second set of lattice characteristics comprises a fourth inclusion shape different than the second inclusion shape, when the multiphase material is in the intermediate state. The first set of lattice characteristics comprises a third periodic pattern different from the first periodic pattern and the second set of lattice characteristics comprises a fourth periodic pattern different than the second periodic pattern, when the multiphase material is in the compressed state.

Embodiments of the present invention can be used to attenuate stress waves at varying frequencies. In some embodiments of the present invention the stress waves operate at frequencies such that the wavelength of the stress waves is less than the length and/or width of the unit cell size of the periodic lattices. For example, in some embodiments of the present invention the stress waves have a frequency of less than 300 kHz.

Another exemplary embodiment of the present invention provides a method of directing a stress wave attenuation pattern through a material. The method comprises providing a material in a decompressed state, wherein a first periodic lattice has a first periodic pattern, first inclusions 110 have a first inclusion shape, a second periodic lattice has a second periodic pattern, and second inclusions have a second inclusion shape, when the material is in the decompressed state. The method can further comprise receiving a force incident to at least a portion of the material, the force causing the material to transition from the decompressed state to a compressed state, the force imparting stress waves that attenuate through the material. The first periodic lattice has a third periodic pattern different from the first periodic pattern, the first inclusions 110 have a third inclusion shape different from the first inclusion shape, and the second periodic lattice has a fourth periodic pattern different from the second periodic pattern, when the material is in the compressed state. The first periodic pattern, the first inclusion shape, the second periodic pattern, and the second periodic inclusion shape can be selected to achieve a desired attenuation pattern for the stress waves.

In some embodiments of the present invention, the force causes the material to transition from the decompressed state to an intermediate state, and then to the compressed state. The first periodic lattice has the first periodic pattern, the first inclusions 110 have the third inclusion shape, and the second periodic lattice has the second periodic pattern, when the material is in the intermediate state.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

What is claimed is:

1. A multiphase material for steering and attenuating stress waves in a predetermined pattern when a force is applied incident to at least a portion of the material, the multiphase material comprising:
a matrix material;
a first periodic lattice of first inclusions positioned within the matrix material, the first periodic lattice of first inclusions having a first set of predetermined lattice characteristics; and
a second periodic lattice of second inclusions positioned within the matrix material, the second periodic lattice of second inclusions having a second set of predetermined lattice characteristics different than the first set of predetermined lattice characteristics,
wherein the first and second sets of predetermined lattice characteristics are selected based on a desired stress wave attenuation pattern when a force is applied incident to at least a portion of the multiphase material.

2. The multiphase material of claim 1, wherein the first and second sets of predetermined lattice characteristics each comprise a distinct periodic pattern, inclusion material, and inclusion size.

3. The multiphase material of claim 1, wherein the first inclusions are softer than the second inclusions.

4. The multiphase material of claim 1, wherein the first set of predetermined lattice characteristics comprises a first periodic pattern the second set of predetermined lattice characteristics comprises a second periodic pattern.

5. The multiphase material of claim 4, wherein at least one of the first periodic pattern and the second periodic pattern changes when a force is applied incident to at least a portion of the multiphase material.

6. The multiphase material of claim 4, wherein at least one of the first periodic pattern and the second periodic pattern and at least one of a shape of the first inclusions and a shape of the second inclusions changes, when a force is applied incident to at least a portion of the multiphase material.

7. A method of achieving a desired attenuation pattern in a material when a force is applied incident at least a portion of the material, the method comprising:
providing a multiphase material in a decompressed state, the multiphase material comprising:
a matrix material;
a first periodic lattice of first inclusions positioned within the matrix material, the first periodic lattice of first inclusions having a first set of lattice characteristics; and
a second periodic lattice of second inclusions positioned within the matrix material, the second periodic lattice of second inclusions having a second set of lattice characteristics different than the first set of lattice characteristics; and
selecting the first and second sets of lattice characteristics based on a desired stress wave attenuation pattern when a force is applied incident to at least a portion of the multiphase material.

8. The method of claim 7, wherein selecting the first and second sets of lattice characteristics comprises selecting a distinct periodic pattern, inclusion material, and inclusion size for each of the first and second sets of lattice characteristics.

9. The method of claim 7, wherein the first inclusions are softer than the second inclusions.

10. The method of claim 7, wherein the first set of lattice characteristics comprises a first periodic pattern and the second set of lattice characteristics comprises a second periodic pattern, when the multiphase material is in the decompressed state.

11. The method of claim 10, further comprising receiving a force incident to at least a portion of the multiphase material, the force causing the multiphase material to transition from a decompressed state to a compressed state,
wherein the first set of lattice characteristics comprises a third periodic pattern different from the first periodic pattern and the second set of lattice characteristics comprises a fourth periodic pattern different than the second periodic pattern, when the multiphase material is in the compressed state.

12. The method of claim 11, wherein the force imparts stress on the multiphase material resulting in stress waves propagating through the multiphase material, wherein the stress waves follow the desired stress wave attenuation pattern.

13. The method of claim 12, wherein the stress waves have wavelength of less than a width and length of a unit cell of the first and/or second periodic lattices.

14. The method of claim 7, wherein the first set of lattice characteristics comprises a first periodic pattern and a first inclusion shape and the second set of lattice characteristics comprises a second periodic pattern and a second inclusion shape, when the multiphase material is in the decompressed state.

15. The method of claim 14, further comprising receiving a force incident to at least a portion of the multiphase material, the force causing the multiphase material to transition from a decompressed state to an intermediate state and then to a compressed state,
wherein the first set of lattice characteristics comprises a third inclusion shape different from the first inclusion shape and the second set of lattice characteristics comprises a fourth inclusion shape different than the second inclusion shape, when the multiphase material is in the intermediate state, and
wherein the first set of lattice characteristics comprises a third periodic pattern different from the first periodic pattern and the second set of lattice characteristics comprises a fourth periodic pattern different than the second periodic pattern, when the multiphase material is in the compressed state.

16. The method of claim 15, wherein the force imparts stress on the multiphase material resulting in stress waves propagating through the multiphase material, wherein the stress waves follow the desired stress wave attenuation pattern.

17. The method of claim 16, wherein the stress waves have wavelength of less than a width and length of a unit cell of the first and/or second periodic lattices

18. A method of directing a stress wave attenuation pattern through a material, the method comprising:
providing a material in a decompressed state, the material comprising:
a matrix;
a first periodic lattice of first inclusions positioned within the matrix, the first periodic lattice having a first periodic pattern, the first inclusions having a first inclusion shape;
a second periodic lattice of second inclusions positioned within the matrix, the second periodic lattice having a second periodic pattern, the second inclusions having a second inclusion shape,
wherein the first periodic lattice has a first periodic pattern, the first inclusions have a first inclusion shape, the second periodic lattice has a second periodic pattern, and the second inclusions have a second inclusion shape, when the material is in the decompressed state;
receiving a force incident to at least a portion of the material, the force causing the material to transition from the decompressed state to a compressed state, the force imparting stress waves that attenuate through the material,
wherein the first periodic lattice has a third periodic pattern different from the first periodic pattern, the first inclusions have a third inclusion shape different from the first inclusion shape, and the second periodic lattice has a fourth periodic pattern different from the second periodic pattern, when the material is in the compressed state, and
wherein the first periodic pattern, the first inclusion shape, the second periodic pattern, and the second periodic inclusion shape are selected to achieve a desired attenuation pattern for the stress waves.

19. The method of claim 18, wherein the stress waves have wavelength of less than a width and length of a unit cell of the first and or second periodic lattices.

20. The method of claim 18, wherein receiving the force causes the material to transition from the decompressed state to an intermediate state, and then to the compressed state,
wherein the first periodic lattice has the first periodic pattern, the first inclusions have the third inclusion shape, and the second periodic lattice has the second periodic pattern, when the material is in the intermediate state.
